(19) United States
(12) Patent Application Publication
(10) Pub. No.: US 2011/0285860 A1
(43) Pub. Date: Nov. 24, 2011

(54) DIGITAL CAMERA WITH UPLOAD FUNCTION

(75) Inventors: Wei-Cheng HUANG, TAIPEI COUNTY (TW); Mei-Yi TSAI, TAIPEI COUNTY (TW); Chih-Liang CHOU, TAIPEI COUNTY (TW)

(73) Assignee: CHICONY ELECTRONICS CO., LTD., TAIPEI COUNTY (TW)

(21) Appl. No.: 12/978,738

(22) Filed: Dec. 27, 2010

(30) Foreign Application Priority Data
May 21, 2010 (TW) 099116353

(51) Int. Cl. H04N 5/225

(52) U.S. Cl. 348/207.1; 348/E05.024

(57) ABSTRACT

A digital camera with an upload function includes an image sensing module, a storage unit, a network interface controller (NIC) and a processing unit. The image sensing module senses to generate a raw datum. The NIC builds connection with a network. The processing unit compresses the raw datum into several compressed datums. The processing unit stores the compressed datums into the storage unit to be taken as several stored files. The processing unit selects a file to be transmitted from the stored files, and makes the NIC transmit the file to be transmitted through the network.

### RELATED APPLICATIONS

This application claims priority to Taiwan Application Serial Number 099116353, filed May 21, 2010, which is herein incorporated by reference.

### BACKGROUND

1. Technical Field

The present invention relates to a digital camera. More particularly, the present invention relates to a digital camera with an upload function.

2. Description of Related Art

As technology develops, there are more and more conventional devices digitalized. Wherein, digital cameras are developed utilizing electrical sensors to convert light into digital information. Complementary Metal-Oxide-Semiconductor (CMOS) and Charge-coupled Device (CCD) are the most popular electrical sensors utilized in digital cameras.

Generally speaking, digital cameras can capture static images or streaming medias, which may be stored in the storage unit of digital cameras, such as memory cards, hard disks, or disks.

Lately, there are more and more web sites for sharing albums or streaming on the network. However, if file sizes of images or streaming media to be uploaded are too large or bandwidth for upload is too narrow, it may take a long to time to upload.

### SUMMARY

According to one embodiment of this invention, a digital camera with an upload function is provided. The digital camera compresses the sensed image or streaming media into the images or streaming media with different file sizes to be selected for upload. The digital camera includes an image sensing module, a storage unit, a network interface controller (NIC) and a processing unit. The processing unit is electrically connected with the image sensing module, the storage unit and the NIC. The image sensing module senses to generate a raw datum. The NIC builds connection with a network. The processing unit includes a compressing module, a storing module and an upload module. The compressing module compresses the raw datum into several compressed datums. The storing module stores the compressed datums into the storage unit. Wherein, the compressed datums stored in the is storage unit are taken as several stored files. The upload module selects a file to be transmitted from the stored files, and makes the NIC transmit the file to be transmitted through the network.

Above all, suitable image or streaming media may be selected for upload. In addition, when the image or streaming media is selected for upload according to the bandwidth, the image or streaming media with better display quality may be selected for upload within an upload time threshold.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawing as follows:

FIG. 1 illustrates a block diagram of a digital camera with an upload function according to one embodiment of this invention.

### DETAILED DESCRIPTION

Reference will now be made in detail to the present embodiments of the invention, examples of which are illustrated in the accompanying drawing. Wherever possible, the same reference numbers are used in the drawings and the description to refer to the same or like parts.

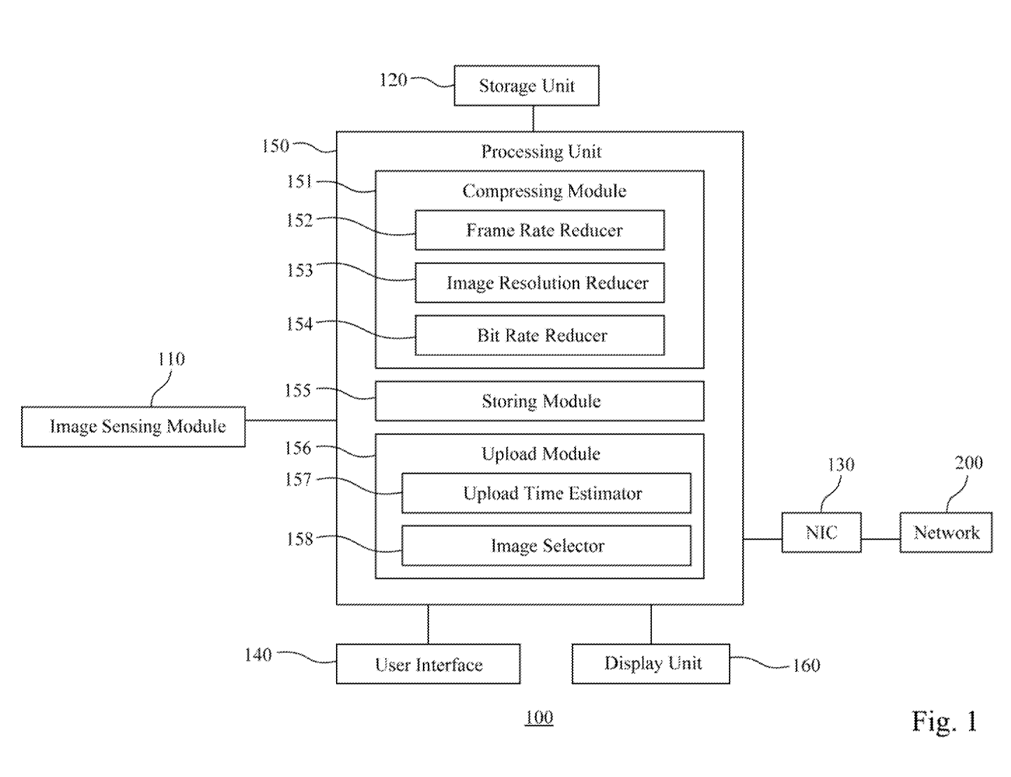

FIG. 1 illustrates a block diagram of a digital camera with an upload function according to one embodiment of this invention. The digital camera compresses the sensed image or streaming media into the images or streaming media with different file sizes to be selected for upload.

The digital camera 100 includes an image sensing module 110, a storage unit 120, a network interface controller (NIC) 130 and a processing unit 150. The processing unit 150 is electrically connected with the image sensing module 110, the storage unit 120 and the NIC 130. The image sensing module 110 may include Complementary Metal-Oxide-Semiconductor (CMOS), Charge-coupled Device (CCD) or other types of image sensors. The storage unit 120 may be a register, a ram, a hard disk drive, a memory card or other types of storage units.

The image sensing module 110 senses to generate a raw datum. The NIC 130 builds connection with a network 200. The NIC 130 may be a wired NIC, a wireless NIC or any other NIC to build connection with the network 200.

The processing unit 150 includes a compressing module 151, a storing module 155 and an upload module 156. The compressing module 151 compresses the raw datum into several compressed datums. Wherein, each of the compressed datums may be compressed with different compress ratio. The storing module 155 stores the compressed datums into the storage unit 120. Wherein, the compressed datums stored in the storage unit 120 are taken as several stored files. The upload module 156 selects a file to be transmitted from the stored files, and makes the NIC 130 transmit the file to be transmitted through the network 200. Wherein, the digital camera 100 may include a user interface 140, which is electrically connected with the processing unit 150. The user interface 140 may be at least one button, a touch screen or other types of user interfaces. Hence, users may operate the user interface 140 to generate an upload instruction to trigger the upload module 156 to start to make the NIC 130 transmit the file to be transmitted through the network 200. Wherein, the raw datums, the compressed datums, the stored files and the file to be transmitted may be images, streaming media or other types of video data. In addition, the storage unit 120 may further store an upload address. Hence, the upload module 156 may make the NIC 130 transmit the file to be transmitted stored in the storage unit 120 to the upload address through the network 200. In other embodiments, users may input the upload address through the user interface 140, which should not be limited in this disclosure.

The upload module 156 may select the file to be transmitted according to the bandwidth of the network 200. In one embodiment, the upload module 156 may estimate time to upload each of the stored files respectively to be taken as the factor to select the file to be transmitted. Therefore, the upload module 156 may include an upload time estimator 157. The upload time estimator 157 estimates time to upload the stored files respectively according to the bandwidth of the network 200. Wherein, the upload time estimator 157 may estimate time icy to upload each of the stored files by dividing the bandwidth of the network 200 from the size of the stored files respectively. In addition, the upload time estimator 157 may transmit the raw datum or a predefined test file to the target address to detect the bandwidth. In another embodiment, the upload time estimator 157 may build connection with a bandwidth detection web site to detect the bandwidth, which should not be limited in this disclosure. Therefore, the upload module 156 may select the file to be transmitted from the stored files according to the estimated time to upload the stored files.

Since file sizes of images or multimedia streams with better display quality are bigger, more time may be needed to transmit images or streaming media with better display quality. Therefore, the storage unit 120 may further stores an upload time threshold, and the upload module 156 may further include an image selector 158. The image selector 158 selects one of the stored files, the estimated time to upload which is the longest among the stored files and shorter than the upload time threshold, to be the file to be transmitted. Therefore, the digital camera 100 can upload the image or streaming media with better display quality within the upload time threshold. In addition, when each of the estimated time to upload the stored files is not shorter than the upload time threshold, the image selector 158 selects one of the stored files, the estimated time to upload which is the shortest, to be the file to be transmitted.

Besides, the digital camera 100 may provide the estimated time to upload each of the stored files through network 200 to users for selecting the file to be transmitted. Therefore, the digital camera 100 may include a display unit 160, which is electrically connected with the processing unit 150. The upload time estimator 157 estimates time to upload the stored files respectively iii and displaying the estimated time to upload the stored files on the display unit 160. Then, the upload module 156 may receive a selecting signal instruction to select the file to be transmitted from the stored files through the user interface 140. In other words, users may select the file to be transmitted through the user interface 140 according to the estimated time to upload the stored files displayed on the display unit 160.

The compressing module 151 may compress the raw datum by reducing the frame rate of the raw datum, the resolution of the raw datum, the bit rate of the raw datum or any other parameter of the raw datum, which may affect the file size of the raw datum. Therefore, the compressing module 151 may include a frame rate reducer 152, an image resolution reducer 153 or a bit rate reducer 154. The frame rate reducer 152 reduces the frame rate of the raw datum to lower frame rates to generate the compressed datums. The image resolution reducer 153 reduces the image resolution of the raw datum to lower image resolutions to generate the compressed datums. The bit rate reducer 154 reduces the bit rate of the raw datum to lower bit rates to generate the compressed datums. In other embodiments, the compressing module 151 may utilize other compression method to compress the raw datum into the compress datums, which should not be limited in this disclosure. In addition, users can decide the number of the generated compress datums through the user interface 140. When the number of the generated compressed dautms is more than 1, the compressing module 151 may compress the raw datums into the compressed datums with several different file sizes. Therefore, there are more different candidates with different file sizes to be selected for uploading through network with different bandwidth.

Above all, suitable image or streaming media may be selected for upload. In addition, when the image or streaming media is selected for upload according to the bandwidth, the image or streaming media with better display quality may be selected for upload within an upload time threshold.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A digital camera with an upload function, comprising:
an image sensing module for sensing to generate a raw datum;
a storage unit;
a network interface controller (NIC) for building connection with a network; and
a processing unit, electrically connected with the image sensing module, the storage unit and the NIC, the processing unit comprising:
a compressing module for compressing the raw datum into a plurality of compressed datums;
a storing module for storing the compressed datums into the storage unit, wherein the compressed datums stored in the storage unit are taken as a plurality of stored files; and
an upload module for selecting a file to be transmitted from the stored files, and making the NIC transmit the file to be transmitted through the network.

2. The digital camera of claim 1, wherein the upload module comprises:
an upload time estimator for estimating time to upload the stored files respectively, wherein the upload module selects the file to be transmitted from the stored files according to the estimated time to upload the stored files.

3. The digital camera of claim 2, wherein the storage unit further stores an upload time threshold, and the upload module further comprises:
an image selector for selecting one of the stored files, the estimated time to upload which is the longest and shorter than the upload time threshold, to be the file to be transmitted.

4. The digital camera of claim 3, wherein the image selector is further adapted for selecting one of the stored files, the estimated time to upload which is the shortest, to be the file to be transmitted when each of the estimated time to upload the stored files is not shorter than the upload time threshold.

5. The digital camera of claim 1, further comprising:
a user interface, wherein an upload instruction is generated through the user interface to trigger the upload module to start to make the NIC transmit the file to be transmitted through the network.

6. The digital camera of claim 1, further comprising:
a user interface, wherein a selecting instruction to select the file to be transmitted is generated through the user interface, such that the upload module selects the file to be transmitted from the stored files according to the selecting instruction.

7. The digital camera of claim 1, further comprising a display unit, the display unit is electrically connected with the processing unit, the upload module comprises:
an upload time estimator for estimating time to upload the stored files respectively and displaying the estimated time to upload, the stored files on the display unit.

8. The digital camera of claim 1, wherein the compressing module comprises:
a frame rate reducer for reducing frame rate of the raw datum to generate the compressed datums.

9. The digital camera of claim 1, wherein the compressing module comprises:
an image resolution reducer for reducing image resolution of the raw datum to generate the compressed datums.

10. The digital camera of claim 1, wherein the compressing module comprises:
a bit rate reducer for reducing bit rate of the raw datum to generate the compressed datums.

11. The digital camera of claim 1, wherein the raw datums, the compressed datums, the stored files and the file to be transmitted are images or streaming media.

12. The digital camera of claim 1, wherein the NIC is a wired NIC or a wireless NIC.

13. The digital camera of claim 1, wherein the storage unit further stores an upload address, the upload module makes the NIC transmit the file to be transmitted to the upload address through the network.

14. A method for a digital camera with an upload function comprising:
sensing a raw datum by the digital camera;
compressing the raw datum into a plurality of compressed datums;
storing the compressed datums into the digital camera, wherein the compressed datums stored in the digital camera are taken as a plurality of stored files;
selecting a file to be transmitted from the stored files; and
transmitting the file to be transmitted through the network.

15. The method for the digital camera with the upload function of claim 14 further comprising:
estimating time to upload the stored files respectively, wherein the file to be transmitted is selected from the stored files according to the estimated time to upload the stored files.

16. The method for the digital camera with the upload function of claim 15, wherein selecting the file to be transmitted from the stored files comprises:
selecting one of the stored files, the estimated time to upload which is the longest and shorter than an upload time threshold, to be the file to be transmitted.

17. The method for the digital camera with the upload function of claim 16, wherein selecting the file to be transmitted from the stored files comprises:
selecting one of the stored files, the estimated time to upload which is the shortest, to be the file to be transmitted when each of the estimated time to upload the stored files is not shorter than the upload time threshold.

18. The method for the digital camera with the upload function of claim 14, wherein compressing the raw datum into the compressed datums comprises:
reducing frame rate of the raw datum to generate the compressed datums.

19. The method for the digital camera with the upload function of claim 14, wherein compressing the raw datum into the compressed datums comprises:
reducing image resolution of the raw datum to generate the compressed datums.

20. The method for the digital camera with the upload function of claim 14, wherein compressing the raw datum into the compressed datums comprises:
reducing bit rate of the raw datum to generate the compressed datums.
